(19) United States
(12) Patent Application Publication
(10) Pub. No.: US 2001/0051927 A1
(43) Pub. Date: Dec. 13, 2001

(54) Increasing web page browsing efficiency by periodically physically distributing memory media on which web page data are cached

(75) Inventors: Mitchell London, Redmond, WA (US); Richard Saville, Redmond, WA (US)

Correspondence Address: Ronald M. Anderson, LAW OFFICES OF RONALD M. ANDERSON, Suite 507, 600 - 108th Avenue N.E., Bellevue, WA, 98004, US

(73) Assignee: BlinkSpeed, Inc.

(21) Appl. No.: 09/877,471

(22) Filed: Jun. 8, 2001

Related U.S. Application Data
(60) Provisional application No. 60/210,583, filed on Jun. 8, 2000.

(51) Int. Cl. H04L 9/00; G06F 17/60

(52) U.S. Cl. 705/51; 380/269; 709/203

(57) ABSTRACT

Data for selected web sites likely to be accessed are stored on memory media (compact disks) that are physically transported to subscribers for use when browsing the Internet. New copies of the memory media with the data for the selected web sites are periodically produced and distributed to the subscribers. In addition, if the data cached on the memory media are stored on a local hard drive of the subscriber, the content of the cache can be updated by a local proxy program during the subscriber's connection to the network when the connection is not otherwise in use. The local proxy program is installed on the subscriber's computer from the distributed memory media. A data center provides Intelligent Prefetching and implements a validation service to determine if the cached data items are current. If not, the current data are loaded into the browser program through the Internet connection.

### RELATED APPLICATIONS

This application is based on prior copending provisional patent application Serial No. 60/210,583, filed on Jun. 8, 2000, the benefit of the filing date of which is hereby claimed under 35 U.S.C. § 119(e).

### FIELD OF THE INVENTION

The present invention generally relates increasing the efficiency and speed with which web pages are viewed by a browser, and more specifically, to providing a cache of web page data stored on memory media periodically distributed to subscribers, for increasing the speed with which the subscribers access web page data with a browser.

### BACKGROUND OF THE INVENTION

Approximately 41% of the total population in the U.S. and about 10% of the total population in the world is connected to the Internet. The vast majority of these connections are limited to 56 kbps modems. Although there has been some growth in broadband connections in the U.S. (broadband connections now account for more than 2% of the total connections in this country), digital subscriber line (DSL), cable modem, and satellite connections to the Internet are generally not yet available in most foreign countries. The cost of broadband connections to the Internet is a limiting factor for many users, since the initial cost can be significant, and the monthly fees for broadband connections are normally three to four times higher than for a conventional telephone line modem connection. While it is likely that someday a majority of people will enjoy the benefits of a high-speed broadband connection, for many years to come, most Internet users will be connected via a conventional modem at speeds typically less than 56 kbps.

Many people become frustrated with the time required to load a web page that includes considerable graphic content, particularly when the web page is loaded in a browser at a data transfer rate of 56 kbps (or less). At such speeds, several minutes may be required to transfer graphic intensive web pages. Furthermore, even over broadband connections, delays in loading web pages are often also incurred, particularly when loading web pages from sites that are being accessed by many users at one time. Such delays can be especially troubling when receiving streaming audio/video data and can adversely affect the quality of the audio or video data reproduction.

One approach commonly used to minimize the delay in accessing web pages by conventional modem or broadband connection is to cache or temporarily store web page data on a user's hard drive, for sites that have been recently visited, with the assumption that a user may revisit sites before the web pages for the sites have been changed. In this case, the cached data can be loaded very quickly into the browser from the hard drive, avoiding the delay in again transferring the data for the web page over the Internet from the original site. However, web page data caches on hard drives are typically limited to only a few megabytes of data, so the benefits derived by using the cached data apply only when a given web page that has been cached is accessed before the cached data are overwritten by the data for different web pages. Also, when any change has occurred in a web page, the cached data stored on the user's hard drive are typically discarded, requiring that the entire web page again be transferred to the user's browser from the site to which the browser is connected. Thus, a primary disadvantage with prior art schemes for cached web page data is that the web page data must at least initially be transferred from a web server at a remote site to a browser before it is stored in the cache on the user's computer, and in many cases, the cached data will be overwritten by subsequent web pages, requiring repeated transfers of the data over the Internet. In any case, the data for a specific web page cannot be accessed in a cache on the user's hard drive if the web page has not yet been accessed by the user.

In addition to caching data for recently visited web sites, certain browser utility applications facilitate prefetching of web pages that are referenced in a current web page being accessed by a browser. If the user then selects a link to one of the prefetched web pages, it will already be either partially or fully cached on the user's hard drive and therefore, will more quickly be accessible by the user's browser. But, if the user moves onto a different web page other than one of the linked web pages that has been prefetched, there will be no advantage to prefetching the data, and previously cached web page data will be overwritten without providing any benefit.

Optical storage media, such as compact disk read only memory (CD-ROM), are able to store about 680 MB of data, which would require more than 48 hours to transmit using a 56 kbps modem connection, or more than 2 hours over a T1 data line. A dual layer, double-sided DVD-ROM can store over 17 GB of data, which require more than 55 days to transmit at 56 kbps, or almost 3 days over a T1 line. Accordingly, it would be desirable to use the tremendous storage capacity of optical storage media to cache commonly accessed web page data, making the data more readily available to a user accessing web pages over the Internet (or other network). Since this type of memory media is relatively low in cost, it should be possible to periodically update the web page data at relatively low cost. Because it is important to minimize the transfer of data over relatively slow Internet connections, the optical storage media on which the cached web page data are stored should be physically transferred or distributed by regular mail (sometimes referred to as “snail mail”) or by courier service. A substantial benefit would arise from making “proactive” cached data available to a user on such a storage medium, since the user would then not be required to have previously visited a web site in order to be able to access the cached data for the page(s) on the web site. By creating and distributing a proactive cache on a storage medium, the user will have access to the data for sites that a user may not yet have visited, but is very likely to visit in the future. It would also be desirable to tailor the cached data distributed on such storage media to different classes of users, since one class of user, e.g., males, will be more likely to visit certain web pages on the Internet, while females (another class) are more likely to visit still other web pages.

Furthermore, the web data that are cached and thus physically distributed on memory media should be refined by statistically monitoring the sites visited by users of the data stored on the distributed memory media, to determine changes in the web page data that are cached in future periodic distributions of subsequently prepared memory media. It would also be desirable to provide content substitution, in which more extensive graphic data cached on the distributed memory media is substituted for simple graphics that would normally be provided by only downloading a web page over the Internet. Currently, no prior art approach is known that provides the above-noted advantages or features.

### SUMMARY OF THE INVENTION

In accord with the present invention, a method is defined for enabling subscribers to a service to more rapidly display any of a plurality of specified online content sources. The method includes the step of periodically collecting and storing data for each of the plurality of specified online content sources on a storage. This step is implemented at a data center that is coupled to the Internet or another network. The data for the plurality of specified online content sources in the storage are then replicated as a data cache, which is stored on each of a plurality of distributable physical storage media, such as CD-ROMs or DVDs. The physical storage medium on which the data cache is stored is distributed to each subscriber of the service. Each subscriber is further enabled to install a proxy program that serves as an interface between the data cache that was received on the physical medium, the network over which online content sources are accessed, and a browser program in which online content sources are displayed to the subscriber. For any online content that is being selectively accessed by a subscriber, any data for the online content that are included in the data cache received on the physical medium are employed to speed the display of the online content. Using the data in the data cache avoids the need to receive the data over the network from a site at which the online content is being accessed.

Subscriber usage data for the subscribers is collected by the service over the network using the proxy program, to determine online content sources that should be included in the plurality of selected online content sources for which data will be collected in the future, for distribution to the subscribers. The usage data indicate the online content sources that are more frequently selected by the subscribers for display with a browser program. Also, the usage data is useful in determining, for each of a plurality of different classes of subscribers, online content sources that will be included in the plurality of specific online content sources for which data will be collected. The data collected are then distributed on the physical media to members of each class of subscribers. These steps ensure that the specific online content sources for each class of subscribers include data for online content sources that are more frequently selected by members of that class for display with a browser program.

Data cache updates are transmitted to a subscriber over the network as a background task, for example, at times when the subscriber is not currently receiving data for displaying any online content. These data cache updates replace expired data in the data caches stored on the physical medium that was previously distributed to the subscriber.

The proxy program is also employed to determine whether the data included in the data cache distributed on the physical medium for a uniform resource locator (URL) on an online content being accessed by a subscriber is current. To carry out this function, the proxy program communicates with the service over the network, to validate the data in the data cache.

Another aspect of the present invention is directed to a method that uses a proxy program to transmit to the service a URL of an online content that is being accessed by a subscriber. At the service, URLs that are included in the online content being accessed and are likely to be accessed by a subscriber are identified, to produce a prefetch list. The prefetch list is transmitted from the service to the subscriber. The proxy program then loads a prefetch cache with data for the URLs that are included in the prefetch list in the background, for example, while other data are not being transmitted to the subscriber over the network. In this manner, a URL for which data have thus been cached is rapidly displayed with a browser program if selected for display by the subscriber.

Yet another aspect of the present invention is directed to the physically distributable memory medium on which is stored a machine readable data cache that includes data for a plurality of selected online content sources. The data cache is used as discussed above.

Still another aspect of the present invention is directed to a system that includes a processor, an output device for displaying online content sources, a network interface, and memory in which machine instructions are stored that cause the processor to implement functions generally consistent with those of the method discussed above.

### BRIEF DESCRIPTION OF THE DRAWING FIGURES

The foregoing aspects and many of the attendant advantages of this invention will become more readily appreciated as the same becomes better understood by reference to the following detailed description, when taken in conjunction with the accompanying drawings, wherein:

FIG. 1 is a schematic block diagram illustrating the functional components employed to collect and distribute data for selected web pages, on optical storage media, in accord with the present invention;

FIG. 2 is a schematic block diagram showing details of a data center that collects data used for producing distributed memory media;

FIG. 3 is a flow chart showing the steps implemented by a local proxy on a user's computer to use the distributed data cache;

FIG. 4 is a schematic block diagram illustrating the components employed in updating the distributed data cache;

FIG. 5 is a schematic block diagram showing the components employed for collecting usage data to determine the web sites for which data should be cached on the distributed memory media;

FIG. 6 is a flow chart showing the logic used by the local proxy program to process the information it receives from a cache validation service provided by a remote data center;

FIG. 7 is a schematic block diagram illustrating the components of a generally conventional personal computer that is employed by a user (or as a server) in connection with implementing the present invention; and

FIG. 8 is a flow chart illustrating the logical steps implemented to prefetch from the data center a list of data items likely to be next accessed, for a web page currently being accessed by a user's browser.

### DESCRIPTION OF THE PREFERRED EMBODIMENT

Overview of Present Invention

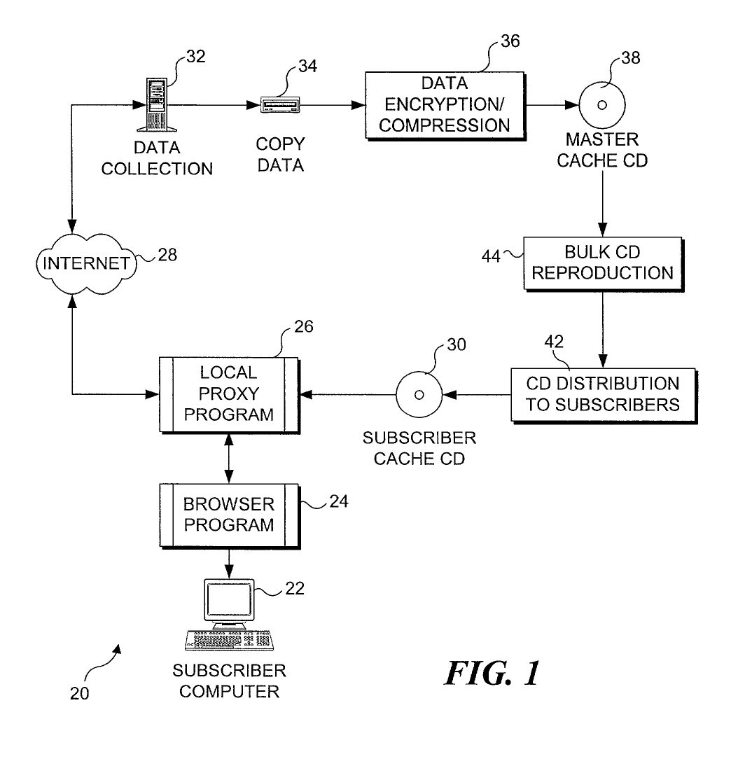

FIG. 1 illustrates the functional elements of a system 20 and software in accord with the present invention. In system 20, an exemplary subscriber personal computer 22 is illustrated to show how the present invention is used to facilitate more efficient browsing of data at a web site. However, it is also contemplated that the present invention can be implemented on many other types of network access devices besides a personal computer, including: lap top computers; work stations, cell phones, paging devices, and personal data assistants (PDAs) with browsing capability; Web TV devices; smart appliances that can access the web; etc., each such device having the ability to connect to a network for accessing data on a selected web page or site.

Subscriber personal computer 22 is running a browser program 24, which can be, for example, Microsoft Corporation's INTERNET EXPLORER™ browser program, or America Online Corporation's NETSCAPE™ browser program. Browser program 24 connects to the network through a local proxy program 26, which is installed on subscriber personal computer 22 and, among other functions, is provided to service requests for data to be loaded from a web site from the browser program and to provide the data to the browser program for display or other purposes (depending upon the type of data received). The local proxy program provides access to the network for browser program 24 and enables use of a distributed cache of data provided on a subscriber cache compact disk (CD) 30 that is physically transferred to a subscriber operating subscriber personal computer 22 (or other network access device).

FIG. 1 indicates that subscriber personal computer 22 is connected to Internet 28; however, it is also contemplated that the present invention is applicable for use with other networks over which data on web pages or sites (typically at remote locations) are loaded into a network access device for display or other purposes. Examples of other types of networks besides the Internet to which the present invention is applicable include intranets, which are frequently implemented on corporate wide area networks (WANs), and future versions of the Internet that are being developed, such as the substantially faster Internet 2, which will initially be used by educational institutions and the government.

When accessing a desired web page or site using browser program 24, a subscriber running subscriber personal computer 22 will clearly prefer that the data included on the desired web page or site be loaded into the browser program for access by the subscriber as quickly as possible, particularly if the subscriber's network access device can access the data at a remote site only over a relatively slow connection. The delay in loading data into the browser program over even a relatively fast broadband network connection can be annoying, as was described above in the Background of the Invention. To avoid or at least substantially reduce such delays, in the present invention, data for web pages that are very likely to be accessed by a subscriber are stored on a memory medium, such as subscriber cache CD 30, and the memory medium is physically distributed by mail, courier service, or other “snail mail” method, so that the subscriber need not load the data for such web pages over the subscriber's connection to the Internet (or other network). Instead, the data for such web pages that are stored on the distributed memory medium can be loaded into the browser program much more efficiently and rapidly from the distributed memory medium through the local proxy program. Optionally, the data stored on subscriber cache CD 30 (or other form of the distributed memory medium) can be copied onto a hard drive (not shown in this Figure) in subscriber personal computer 22. For other types of network access devices, the data stored on the distributed memory medium can be copied to other forms of non-volatile memory that may be included or available to the network access device. However, in many cases, a subscriber may prefer to not copy all of the data from the distributed memory medium to a local non-volatile memory, but instead, load the data into the browser from the distributed memory medium through the local proxy program. Data for a web page that is being accessed by the browser program will then be loaded either from the hard drive, if copied thereto, or from the subscriber cache CD or other form of distributed memory medium.

Proactive Cache

The data stored on a distributed memory medium, such as subscriber cache CD 30, is referred to as a “proactive cache,” since it is available even if the subscriber has not previously visited the web page for which the data has been cached on the distributed memory medium. In contrast, a conventional cache that is maintained by a browser such as Microsoft Corporation's Internet Explorer, only contains data that has been loaded into the cache over the network connection when the user has previously visited a web page or site from which the data were loaded into the browser program. While data in a conventional cache greatly improves the performance of a browser program when the web page or site is next visited (assuming that the data in the conventional cache have not yet been overwritten with different data), a conventional cache does not include data for any web page or site that a browser program has not yet accessed. Furthermore, a conventional cache contains only data that have been transferred to a user's hard drive over a network connection. In contrast, the present invention periodically transfers the distributed memory medium to the subscriber's personal computer or other network access device via snail mail or other means of physical transfer.

Cache Contents

In most cases, the subscriber cache CD or other form of distributed memory medium will include animations such as AVI or MPEG files, graphic files in formats such as GIF, JPEG, and BMP, and audio files in formats such as WAV and MP3. The data stored on the distributed memory media will be for web sites selected as being most likely to be visited by subscribers. In addition, for some frequently visited web pages or sites that include relatively complex layout, it may be appropriate to include the complete HTML/XML data for a web page at that site, particularly if the files for the web page are relatively large in size.

The proactive cache of data stored on distributed memory media such as subscriber cache CD 30 will be collected only from selected sites. The sites from which data will be stored on the distributed memory media may be initially determined from information gathered from various sources on the Internet. One such source frequently updates a list of the 100 most-visited web sites. As explained below, it is likely that the web sites for which data are stored on the distributed memory media will be changed to reflect the actual usage of subscribers. The web sites that are visited by subscribers will be determined based upon data collected from the subscribers as they connect to various web sites on the Internet (or other network).

In addition, it is also contemplated that a choice of web sites for which data will be included on the distributed memory media can be different for each of a set of predefined classes of subscribers. For example, a class defined as “male subscribers in the 20 to 35-year age range” will most likely visit different web sites and access data on those web sites than would a class defined as “female subscribers in the 20 to 35-year age range.” As a further example, a class may be defined for subscribers who are interested in a particular hobby and who will prefer to visit web sites related to that hobby. Thus, data for a specific set of web sites that subscribers in any such defined class will most frequently visit can be collected and stored on a distributed memory media for distribution to subscribers in that class.

As shown on the upper portion of FIG. 1, the data for each of the web sites selected for inclusion on the distributed memory media are collected by a server 32 that accesses the web sites to download the data from Internet 28 (or other network). Server 32 then transfers the data that are downloaded to a CD (or other memory medium) read/write drive 34, which applies a data encryption algorithm and a compression algorithm to respectively encrypt and compress the data stored on a master cache CD 38 (or other memory medium). Preferably, the encryption and compression is accomplished with Inner Media, Inc.'s DYNAZIP™ software library, although other types of compression and encryption algorithms and programs are equally applicable to this task. The data on master cache 38 are then input to a bulk CD reproduction system, as indicated in a block 44, to produce the plurality of subscriber cache CDs 30 (or other form of distributed memory media, such as DVDs) that are distributed to the subscribers, as indicated in a block 42. If subscriber cache CDs appropriate for different classes of subscribers are prepared, the same steps are applied for each class of subscriber, so that each member of the class receives a subscriber cache CD on which data appropriate for the web sites most likely to be visited by that class of subscriber are stored.

Since the data on the subscriber cache CD are encrypted, the data cannot be simply accessed by the subscriber using a file viewing program. Instead, the data stored on the distributed memory medium for a specific web site can only be accessed when the subscriber has connected to that web site with the browser program. Access of the cached data on the CD or data that was copied from the subscriber cache CD onto the subscriber's hard drive or other local storage occurs when the subscriber's browser interacts with local proxy program 26. Since all requests from the browser to load data from a web page or site pass through local proxy program 26, it can readily determine whether the data for a web site being accessed by the subscriber are included within the data on the distributed memory media. Local proxy program 26 is also responsible for decrypting and decompressing the data stored on the distributed memory media when it is necessary to load the data into browser program 24 for use by the subscriber. Further details of the local proxy program and the functions it performs are discussed below.

Data Center

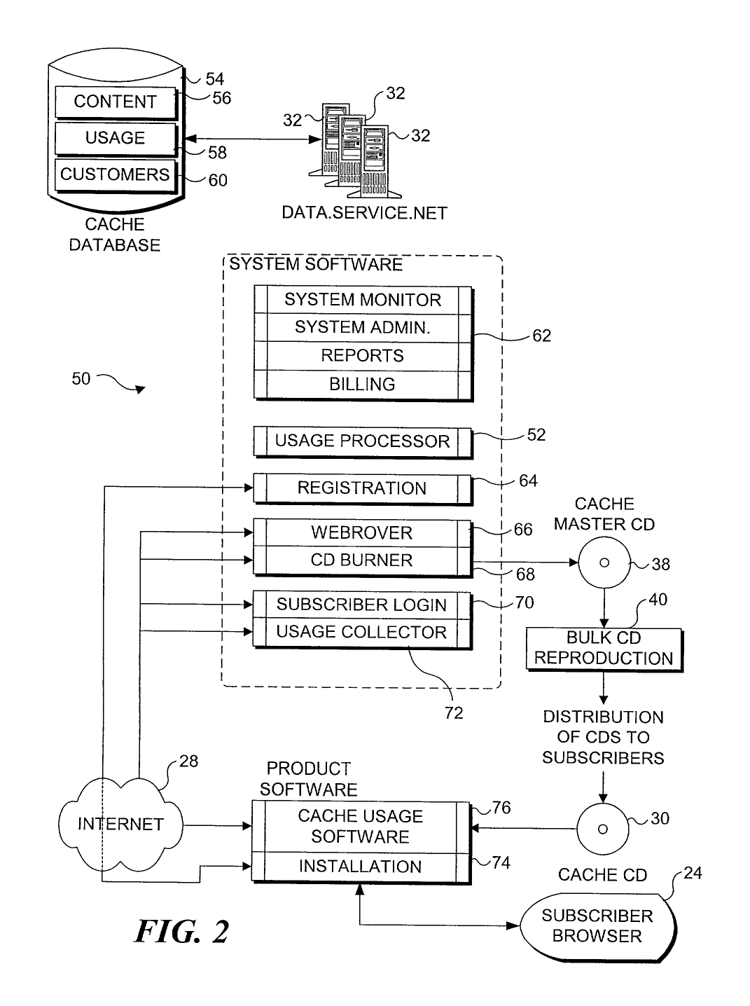

Turning now to FIG. 2, details of a data center 50 at which data are collected for use in both determining the web sites for which data will be cached on the distributed memory media and for collecting the data stored on the distributed memory media are illustrated. Data center 50 has a presence on the network indicated by its address “data.service.net.” It is expected that the present invention will be marketed under the trademark “BLINKSPEED,” which will apply to the data center, the distributed memory media, and to the services provided by the data center. The data center accesses various web sites that have been selected as those most likely to be visited by subscribers (or by a class of subscribers) to download and collect the data that will be sent on the distributed memory media to the subscribers. At the data center, several servers 32 implement various system software functions, including administrative functions 62. These administrative functions are related to tasks such as system monitoring, system administration, preparation of reports, and billing subscribers for the services rendered. A usage processor 52 is also included for analyzing data regarding both the use by the subscribers of the data provided on the distributed memory media and also, for collecting information identifying the web sites and files that are most frequently accessed by the subscribers. The usage data can then be applied to determine the web sites or data files that are most likely to be visited by the subscribers and the data that will be most useful to subscribers (or classes of subscribers, as described above). Analysis of the collected data will likely be on a Target Domain level, to determine which domains to add/drop from the cache and to what depth each selected domain should be further traversed in order to, optionally, collect additional data for inclusion in the cache.

Servers 32 are coupled to a cache database 54. This cache database includes the content of the cache distributed to subscribers on the distributed memory media, as indicated in a block 56, usage data relating to the web sites accessed by subscribers, as indicated in a block 58, and data identifying customers (subscribers) as noted in a block 60.

A person wishing to subscribe to the services of the data center can contact data.service.net over the network and will interact with a registration module 64. The registration process enables the person to input information such as the person's name, residential and mailing addresses, demographic information, and credit related information used in billing for the services rendered. All subscriber information will be kept confidential. The registration process will also likely include the step of assigning a subscriber user name and password to the registrant, so that proprietary information related to the services provided will be accessible by the subscriber upon connecting to a home page of data.service.net over Internet 28 (or other network). Each time that a subscriber uses the browser program, the local proxy program will log the subscriber into the data center using the subscriber name and password, so that usage data and other services related to the subscriber can be performed by the data center.

Also connected to Internet 28 is a WebRover 66 and a CD burner 68, which is an expression referring to a CD read/write drive that is used to produce cache master CD 38. WebRover 66 is employed to access the web sites from which data are to be downloaded for use in creating cache master CD 38.

A subscriber login block 70 and a usage collector block 72 are also included. Each time that a subscriber uses the browser program, the local proxy program will log the subscriber into the data center site using the subscriber name and password, so that usage data and other services related to the subscriber can be performed by the data center, but this log in will be transparent to the subscriber. Usage processor 52 services the data collected by usage collector 72, including the identification of uniform resource locators (URLs) for web pages and data included thereon that are accessed by subscribers. Subscriber login block 70 is also employed when a subscriber logs into the data center for purposes of inquiries concerning billing or for other administrative matters.

Included on each subscriber cache CD 30 that is distributed to subscribers is installation software, as noted in a block 74, and software employed for monitoring usage of the cache, as indicated in a block 76. When the installation software is run, it creates local proxy program 26 and configures the subscriber's browser program to use the local proxy program so that all requests from the browser pass through the proxy software. Cache usage software 76 is employed for collecting usage data for the subscriber, for transmission to data center 50, to facilitate identifying web sites and related data that may be included on the next periodic release of the distributed memory media to subscribers.

A copy of the distributed memory medium will be released to each subscriber at least on a quarterly basis, and for premium subscriptions, on a more frequent basis, such as each month. Clearly, more frequent releases of cached data on the distributed memory media will insure that the data are more likely current and have not been replaced on the web site from which originally collected by the data center.

Local Proxy Program

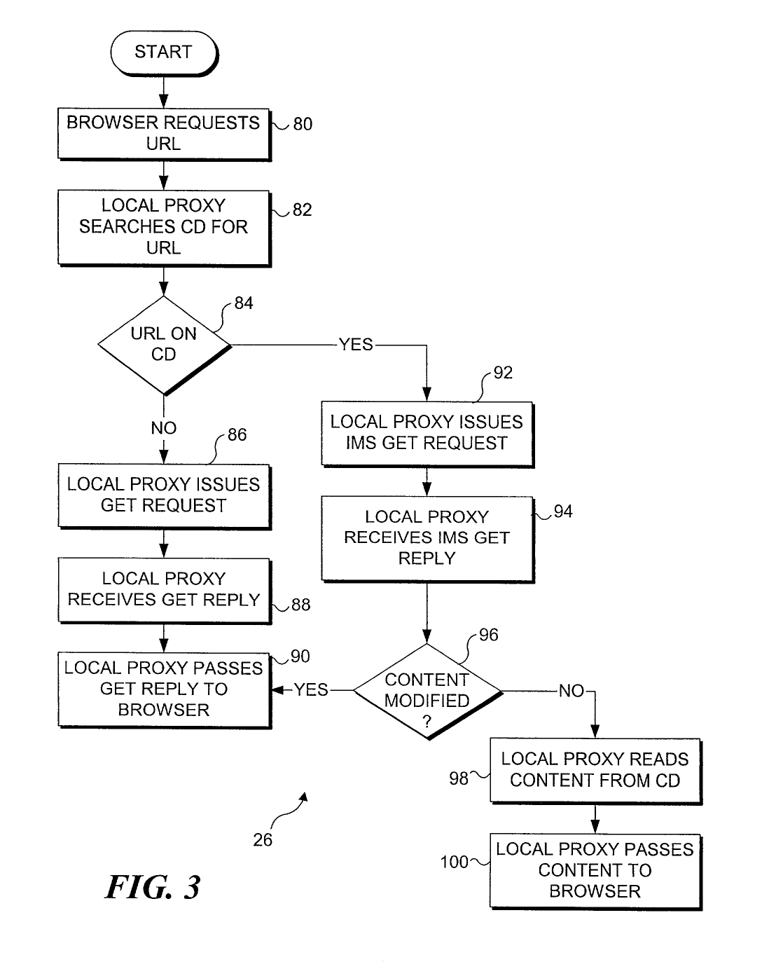

Further details of the local proxy program and the functions it performs are illustrated in FIG. 3. Local proxy program 26 services a request by the browser to load a web page identified by a URL address, as is commonly used on the World Wide Web. This step is indicated in a block 80. In a block 82, the local proxy program searches the CD or other form of the distributed memory medium accessible by the subscriber's computer or other network access device, for the URL requested by the browser. A decision block 84 determines if the data identified by the URL is on the distributed memory media and if not, the local proxy program issues a “GET request” in a block 86. In response to the request, data identified by the URL are transferred to the local proxy program via the connection to the remote site over the Internet (or other network) so that in a block 88, the local proxy program receives a “GET reply.” The GET reply comprises the data that were requested. In a block 90, the local proxy program passes the GET reply to the browser program for display or other use. Note that audio file data that are transferred to the browser program will be played or heard, and in that sense, are also “displayed” by the browser program.

In decision block 84, if the URL is for data stored on the distributed memory media, the logic proceeds to a block 92 in which the local proxy program issues an “if modified since” (IMS) GET request. This request is serviced by the remote system that hosts the content specified by the URL, resulting in an “IMS GET reply,” in a block 94. In a decision block 96, the local proxy program determines if the content that is returned from the distributed memory media is current, i.e., if the corresponding data on the web site being accessed by the browser are newer and thus, possibly different than the data requested from the distributed memory medium. This determination is made by comparing a time stamp of the file for the data being accessed on the distributed memory media with that of the corresponding file on the web site to which the browser is connecting over the network. Assuming that the time stamp for the data file at the web site is newer than for the file on the distributed memory medium, the logic proceeds to block 90, in which the local proxy program enables the browser program to download the requested data for the web site so that it is available to the browser to display or for other use by the subscriber. However, if the content has not been modified in decision block 96, the local proxy program reads the data content from the CD or other distributed memory medium corresponding to the URL in a block 98. The content is passed to the browser program for display or other use, in a block 100.

Proactive Cache of Streamed Media

It should be noted that the display or other use of content stored on the distributed memory medium occurs substantially faster than the corresponding content can be loaded into the browser program over a network connection to the web site being accessed. This facility is useful when accessing streamed media at a web site. In a conventional browser, there is almost always a delay before selected streamed media are displayed (or otherwise played), since the browser program will initially load a buffer with a first portion of the streamed media file. The present invention cannot provide a benefit for live broadcasts of streamed media, since it is not possible to cache any portion of the streamed media on a subscriber's personal computer before the streamed media is transmitted over the Internet. However, if a web page being accessed includes static streamed media (such as AVI file, files in the Moving Picture Experts Group (MPEG) format, or REALNETWORKS™ format streamed data), the present invention will enable the browser program to begin displaying the animation file substantially faster than could otherwise occur. While the entire file for streamed media may be included on the distributed memory media, an alternative is to include only a first portion of such files. Since the first portion of such a file is immediately available locally from the distributed memory medium, it will be unnecessary to wait for the browser program to load a buffer with the initial part of the file over the network connection. While the browser program is playing the initial portion of the file that was loaded from the distributed memory media, the remainder of the file can begin transferring to the browser program buffer over the Internet in the background, thereby minimizing, if not completely eliminating, the delay before the file begins playing on the subscriber's browser program.

Background Update of Proactive Cache

Although the distributed memory medium will be updated periodically as copies of newer versions are distributed by regular mail or by courier service to subscribers, it is likely that at least some of the data included on the distributed memory medium used by a subscriber will become out of date before the next distribution occurs, as data on the web sites from which the distributed data were originally collected change. One approach for ensuring that the subscriber has current data is to distribute updated data to the subscribers over a network connection during times when the subscriber is viewing a web page so that the transfer of the updated data will not interfere with the web page currently being viewed.

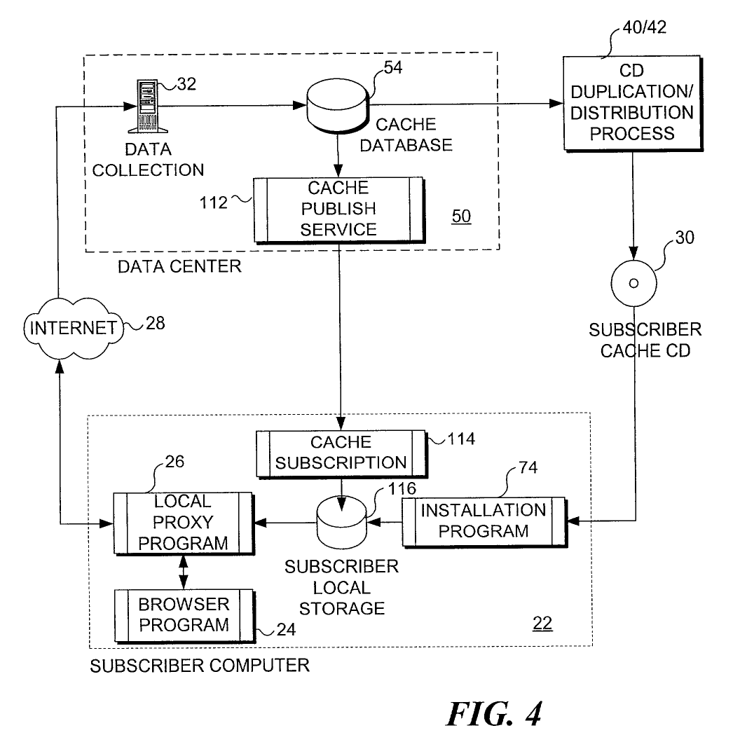

FIG. 4 illustrates how the cache of the distributed memory medium available to the subscriber is updated, but this approach can only be used if the subscriber has elected the option to copy the cache from the distributed memory medium to a hard drive 116 (or other non-volatile local memory). In this scheme, the subscriber's personal computer 22 (or other Internet access device) will access a cache publishing service 112 provided at data center 50. The cache publishing service will transmit updated files to replace the files stored on the hard drive that were copied from the distributed memory media previously mailed or otherwise physically transferred to a subscriber, which are no longer current. To obtain the updated files, server 32 will access the selected web sites for which data were stored on the distributed memory media through Internet 28 and will determine whether the data files previously distributed on the memory media are current. If not, the current files will be downloaded from those web pages. Cache publishing service 112 will then encrypt and compress the updated files, which will be transmitted over the Internet or other network to a cache subscription module 114 running on subscriber's personal computer 22. Installation program 74 installs the cache subscription module, making it available to local proxy program 26. The local proxy program runs the cache subscription module when the connection to the Internet is not being otherwise used for loading data required by the browser program. During this time, the local proxy program will have logged the subscriber into the data center and will receive the updated files from cache publishing service 112. Cache subscription module 114 adds the encrypted and compressed updated files to the cached data that were copied from subscriber cache CD 30 onto hard drive 116 in the subscriber's personal computer. The updated files are then available if the subscriber connects to any web site from which these data files were obtained.

Usage Data Collection

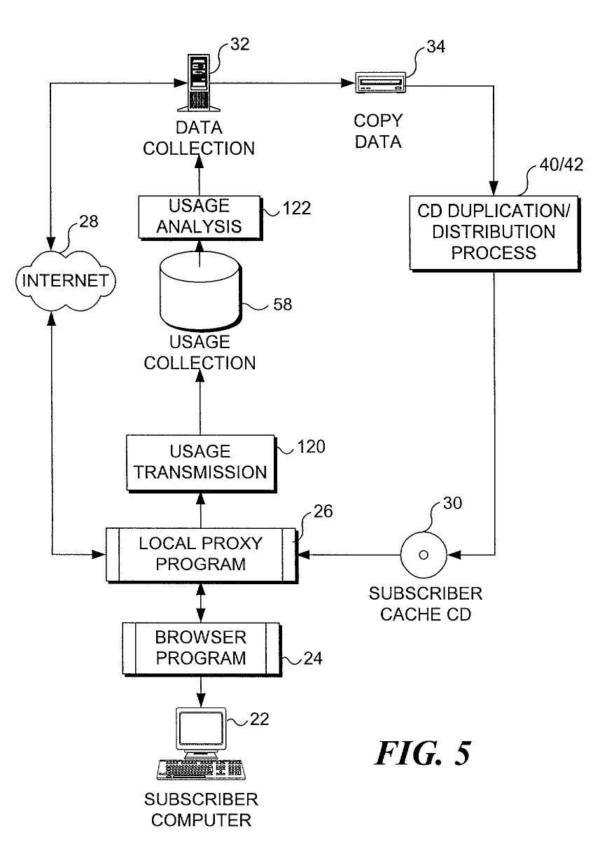

Further details of the system components used for collecting information regarding usage of the data on the distributed memory media and information identifying the web sites being accessed by subscribers are illustrated in FIG. 5. As shown therein, local proxy program 26 monitors each request made by browser program 24 to access data at a web site through Internet 28. Each time that a web site is accessed, and data on a web page are loaded from subscriber cache CD 30, local proxy program 26 records the usage of the subscriber cache CD. Furthermore, if the data are not available on the subscriber cache CD because the subscriber is connecting to a web site for which data have not been stored on the subscriber cache CD, the local proxy program also makes note of the URL for that web site. The URLs for the web sites and data that are accessed by browser program 24 at the request of the subscriber are then transmitted to data center 50 as packets, as indicated in a usage transmission block 120 and collected in usage database 58 at the data center. As noted in a block 122, the data collected regarding usage are analyzed to determine which web sites are most popular and the data files on those web sites that are most frequently being accessed by subscribers. In addition, as noted above, different classes of subscribers may be defined for which the usage analysis is performed to develop class-specific data regarding web site access statistics. The analysis then determines for a given class of subscriber, the web site and data files that are most popular so that on the next revision of the distributed memory media for that class of subscribers, data for the more popular web sites that are most likely to be visited by that class of subscriber can be included.

Real Time Cache Validation

Virtually every type of caching scheme requires that the contents of the cache be validated before being delivered to a browser program to avoid providing information that is stale or out of date. The preceding statement is also true of the present invention. Steps must thus be taken to ensure that data loaded into the browser from the cache provided by the data center on the distributed memory medium are current, to avoid the subscriber failing to receive the information that is currently provided at the web site being accessed. To validate the data content included in a cache, including that of a conventional cache, the browser program or other software that manages the cache must send an IMS GET request for each item it intends to return from the cache. However, this step adds a delay in the overall response time for loading data from the cache.

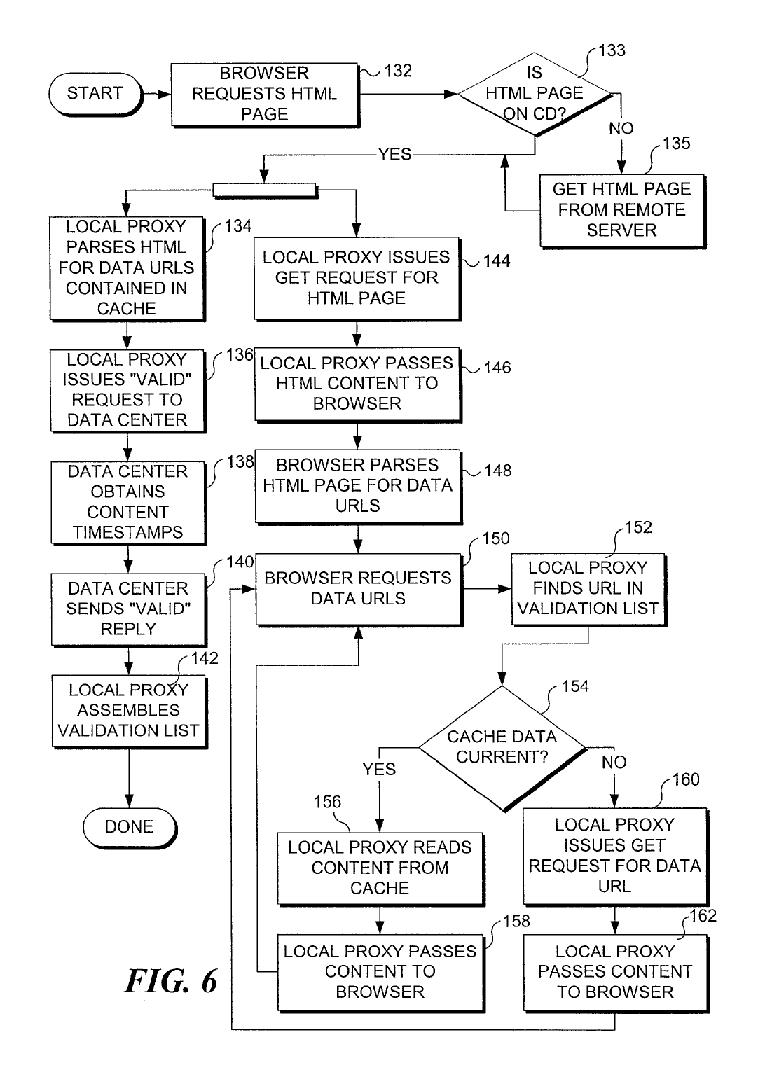

While it is still necessary to validate the content of the data distributed to subscribers on the distributed memory media, the present invention provides a more efficient way to perform cache validation. Details of this technique are illustrated in FIG. 6. This scheme relies upon the ability of data center 50 to provide a cache validation service and of the local proxy program that is running on the subscriber's computer to use the services of the data center for cache validation. In the present invention, the local proxy program must determine the currency of each data item on the distributed memory medium before that item is returned to the browser program. The files for data items stored on the distributed memory medium, such as *.GIF, *.JPG, and *.WAV files, etc., include a time stamp. The currency of the data items in the cache is determined by issuing a HEAD request to the server hosting the data at a remote web site and comparing the time stamp that is returned for that data item at the web site to the value for the corresponding data item on the distributed memory media. If the comparison indicates that the data on the distributed memory media are current because the time stamp for the data item on the subscriber cache CD matches that of the corresponding data item at the remote site, then the data from the subscriber cache CD can be returned to the browser program. However, if time stamp comparison indicates that the data item in the cache is old, then the current data for that item must be downloaded over the Internet through the connection between the browser program and the host server for the remote web site being accessed.

The data center provides a validator service that assists the local proxy program in determining if specific data on the distributed memory media are current and therefore valid. The reduction in validation times provided by the validator service is due in part to the fact that the data center has faster access to the various servers for the web sites on the network and therefore experiences a substantially shorter round-trip time for HEAD requests issued to obtain time stamps for data items on a web page. To employ the validation service, the local proxy program must “anticipate” the data items that will be requested by the browser program for a given HTML web page file, so that the validation can be accomplished before the data items must be passed to the browser program from the cache.

The validator service is divided into three phases. The first portion of the process is directed to a list assembly phase in which a list of URLs for the data items contained on an HTML web page that has been requested by the browser program is assembled by the local proxy program. This URL list is then transmitted by the local proxy program to the validator service running at the data center so that it can issue HEAD requests for each URL in the list and assemble a reply packet for return to the local proxy program that made the request for validation service. As the local proxy program receives requests from the browser for data items on the HTML page, it uses the URL list to determine if the cache on the distributed memory media contains a current version of the data item that is requested.

Details of these three phases that are implemented to provide the validator service are shown in FIG. 6, beginning with a block 132 in which the browser requests an HTML page. This request is received by the local proxy program, which in response, determines if the requested HTML page is included in the data cached on the distributed memory medium, as noted in a decision block 133. If not, the local proxy program issues a GET HTML page request to obtain the HTML page from the remote server on which it is stored, as shown in a block 135. Following a receipt of the requested HTML page, or if the response to decision block 133 is affirmative, the local proxy program initiates two parallel processes. In a block 134, the local proxy program searches the cache for the HTML page requested. If the HTML page is found, the local proxy program parses the HTML page to identify data URLs that are contained within the cache provided on the distributed memory media. In a block 136, the local proxy program then issues a VALID request to the data center in which the list of URLs is included. The VALID request is a proprietary protocol used for communication between the local proxy program and the validator service provided by data center 50. Upon receiving the VALID request from the local proxy program running on a subscriber's personal computer or other network access device, the validator service sends a HEAD request to each site identified in the list of URLs. In response, a HEAD reply is received by the validator service from the respective sites identified by the URLs in the list. The HEAD reply includes the content time stamps for each of the data items identified by the URLs. This step is indicated in a block 138. The validator service processes each HEAD request and assembles a VALID reply, which is sent to the local proxy program in a block 140. The local proxy program uses the VALID reply to update the time stamp fields for the items in the URL list.

The other parallel process running upon receipt of a browser request for an HTML page begins in a block 144 in which the local proxy program issues a GET request for the HTML page indicated in block 132. The local proxy program then passes the HTML content for the web page that was requested, in a block 146. In a block 148, the browser parses the HTML page for the data item URLs that are included therein and, in a block 150, the browser program requests the data item URLs. A block 152 provides for the local proxy program to find the requested data URLs in the validation list that was assembled in a block 142. A decision block 154 determines if the cached data are current by comparing the current time stamp for the requested data URLs in the validation list with those for the corresponding data items in the cache stored on the distributed memory media. If the cached data are current, based upon the time stamps being equal, the local proxy program reads the content from the cache in a block 156 and in a block 158, passes the content to the browser program for display or other use. The process then loops back to block 150 to process the next data URL requested by the browser and passed to the local proxy program in block 152.

If the data cache is not current, a block 160 provides that the local proxy program issues a GET request for the data item URL so that the data item will be loaded into the browser over the Internet (or other network) connection from the remote site at which it is stored instead of being loaded from the cache. The local proxy program then passes the content that was obtained over the network connection to the browser program in a block 162 and returns to block 150 to process the next data item URL. If the data item URLs that are being requested by the browser program are not stored on the distributed memory media, or if the assembled validation list is not completed and received from the data center in time, the steps in blocks 160 and 162 are carried out to obtain the requested data item through the network connection.

Personal Computer System for Implementing the Present Invention

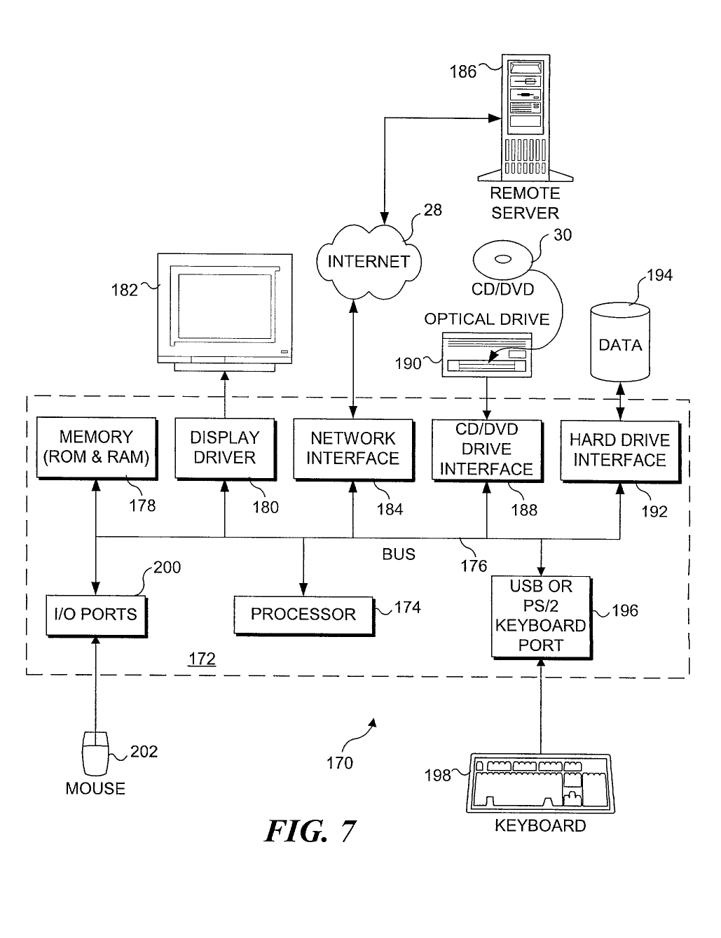

While a variety of network access devices other than a personal computer can be used for connecting to remote web sites over the Internet or other network, it is expected that at least initially, the present invention will be most frequently used with personal computers that access the Internet using a conventional browser program. FIG. 7 illustrates an exemplary personal computer and some of the functional components that are included therein for implementing the present invention. It should also be noted that server 32 at the data center includes components substantially identical to those that are included in personal computer 170, for carrying out the functions described above, at the data center.

Computer 170 includes a processor chassis 172 in which a processor 174 is connected to a data bus 176. Also connected to data bus 176 is a memory 178, including both read only memory (ROM) and random access memory (RAM). Memory 178 temporarily stores machine instructions that, when executed by processor 174, cause it to carry out the functions described above, which are implemented by the subscriber's personal computer, or alternatively, by server 32 at the data center, to carry out the functions described in connection with the services performed by the data center in the present invention. These machine instructions are typically stored along with other data on a hard drive 194, which is connected to data bus 176 through a hard drive interface 192 and are loaded into memory 178 from the hard drive.

Also connected to data bus 176 is a display driver 180 that provides a video signal used to drive a monitor 182 on which text and images are displayed under the control of processor 174. A network interface 184 is connected to bus 176 and provides access to the Internet (or other network) to enable connection to a remote server 186 on which web pages and data files may be stored for access by the browser program running on personal computer 170 or by other software requiring access of the files stored on or accessible through remote server 186. The network interface may comprise a conventional modem, an Integrated Services Digital Network (ISDN) interface, or a network interface card that provides access to the Internet through a local area network (LAN). For example, the network interface (or personal computer) may connect to the Internet through a digital subscriber line (DSL) interface or through a cable modem. A CD/DVD drive interface 188 provides access to data stored on subscriber cache CD 30 (or a DVD disk), which is read by an optical drive 190 connected to the CD/DVD drive interface. Also coupled to data bus 176 are I/O ports 200, one of which may be connected to a mouse 202, and a PS/2 keyboard port 196, to which a keyboard 198 is connected for input of text and commands by the user.

If network access devices other than a personal computer are used, they will typically include at least a processor, a memory, a display driver coupled to a display, non-volatile memory for data storage, at least a keypad, and appropriate interfaces thereto, or alternatively, one or more integral circuits in which these functional components are implemented. In addition, most network interface devices will include a network interface, and/or a wireless network connection.

Intelligent Prefetching

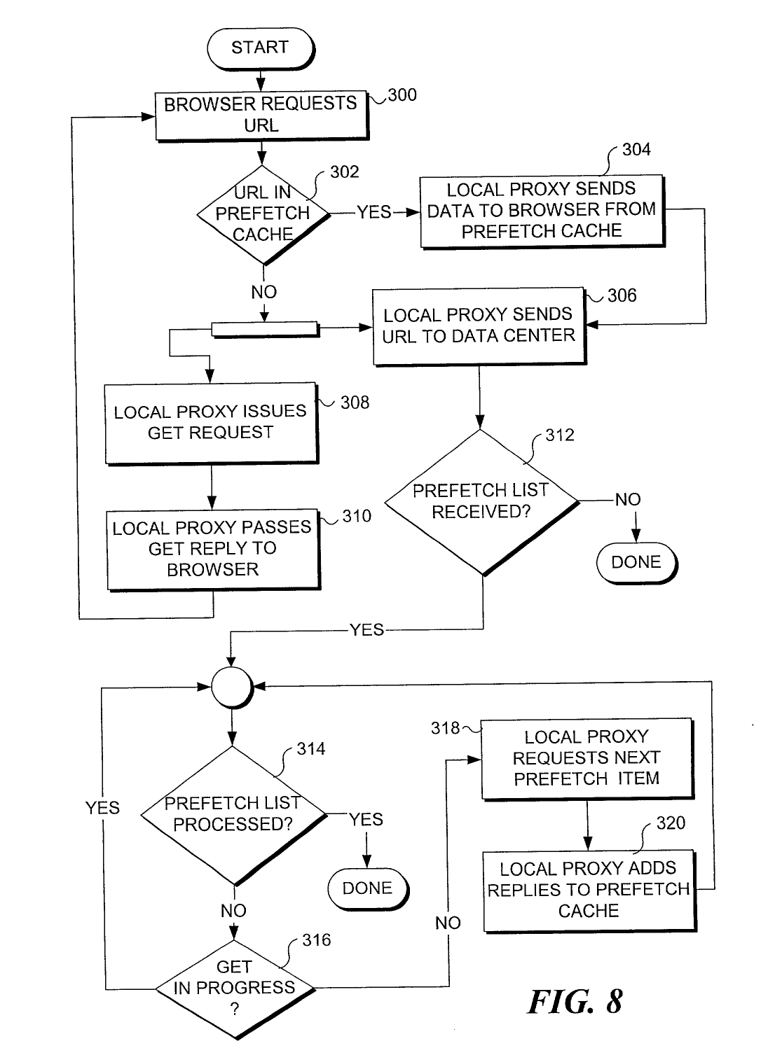

Another service provided by the data center, called “Intelligent Prefetching,” is shown in FIG. 8. Browser program performance is substantially enhanced in this aspect of the present invention, by prefetching data for other web pages referenced on a web page that is currently being accessed by the browser program, where the other web pages are likely to be accessed by a subscriber in the current browsing session. The Intelligent Prefetching service anticipates the web pages that the subscriber will likely select from the web page currently being loaded into the browser program. The technique used for the Intelligent Prefetching in the present invention uses conventional browsing programs and conventional remote web servers on which web page content is stored. However, the local proxy program installed by the present invention receives prefetch information from the data center to improve the performance of the browser program. Details of the Intelligent Prefetching method are shown in FIG. 8.

In a block 300 in FIG. 8, the browser program requests a URL for a web page that is about to be loaded into the browser program. A decision block 302 determines if the URL is already in a prefetch cache and if so, as indicated in a block 304, the local proxy program sends the data that are in the prefetch cache to the browser program, which can immediately load the data, since it has already been downloaded over the network. Next, in a block 306, the local proxy sends the URL for the web page that is being loaded into the browser program to the data center.

If the result in decision block 302 is negative, indicating that the URL is for a web page or data item that is not in the prefetch cache, two processes are initiated. A block 308 indicates that the local proxy program issues a GET request for the web page being loaded. In a block 310, the local proxy program passes the GET reply, i.e., the content that has been transmitted over the network in response to the GET request, to the browser program, enabling the browser to display or otherwise use the requested URL. The logic then returns to block 300. Concurrently with blocks 308 and 310, the step in block 306 is executed as described above, so that the local proxy program sends the URL to the data center. After block 306, a decision block 312 determines if a prefetch list has been received from the data center. The data center, once provided with the URL for a web page being loaded into the browser program, consults a data file for that URL to identify the URLs for that web page that will most likely next be requested by the subscriber. The data center transmits this list of potential URLs to the local proxy program. However, if the reply from the data center indicates that it has no prefetch information for the requested HTML page, the logic concludes. On the other hand, if a prefetch list has been received from the data center, the logic continues with a decision block 314 that determines if the prefetch list that was received has been processed by the local proxy program. If so, again, the logic is completed, since the likely URLs will have been prefetched by the local proxy program. However, if the prefetch list has not yet been processed, a decision block 316 determines if a GET is in progress. If so, the logic simply loops back to decision block 314. If not, the logic continues to a block 318 in which the local proxy program requests the next prefetch item. This request anticipates that the user will select one of the URLs in the current web page being browsed and therefore requests the data for the URL so that it can be prefetched and be available when and if the user in fact selects it to next be displayed by the browser program. In a block 320, the local proxy program adds the replies, i.e., the content for the prefetched item, to the prefetch cache. The logic then loops back to decision block 314.

By following the logic outlined in FIG. 8, a prefetch cache is loaded with data that may next be selected for access, and the prefetching of the data enables the browser program to much more rapidly access the data that are referenced in the current web page being browsed, if the data are selected by the subscriber. By anticipating and obtaining most likely URLs referenced in the web page currently being browsed and holding the data in a prefetch cache, the data are available to be returned to the browser program if and when requested.

The data center produces the prefetch list of URLs for popular web pages and stores the list in the database that is stored in a database by analysis of user accessed data. One approach for acquiring the data used for compiling the prefetch list is through analysis of the usage made by subscribers of the proactive cache system distributed as described above. By analyzing subscriber usage information, it should be possible for the data center to determine, for example, that on a specific popular web page, only three of five available data items are of interest to most users and are likely to be selected for loading by a user. Intelligent Prefetching is thus an additional service provided by the data center to subscribers, but could be independently provided, separate and apart from the physical distribution of memory media on which data are cached.

Although the present invention has been described in connection with the preferred form of practicing it and modifications thereto, those of ordinary skill in the art will understand that many other modifications can be made to the invention within the scope of the claims that follow. Accordingly, it is not intended that the scope of the invention in any way be limited by the above description, but instead be determined entirely by reference to the claims that follow.

The invention in which an exclusive right is claimed is defined by the following:

1. A method for increasing a speed with which at least a portion of an online content stored at a first location is displayed to a user at a second location connected in communication with the first location over a network, comprising the steps of:
(a) storing data for said at least the portion of the online content as part of a data cache on a physical medium that includes data for a plurality of specified online content sources;
(b) distributing the physical medium on which is stored the data cache for the plurality of specified online content sources to the user; and
(c) when the user at the second location has connected to the first location and has selectively chosen to display the online content, displaying the online content to the user with the data for said at least the portion of the online content included in the data cache, said online content being displayed to the user substantially faster using the data that were stored in the data cache on the physical medium than if all data for the online content were instead transferred over the network from the first location to the second location.

2. The method of claim 1, further comprising the steps of:
(a) encrypting data for the plurality of online content sources stored in the data cache of the physical medium prior to the step of distributing; and
(b) decrypting the data for said at least the portion of the online content prior to the step of displaying the online content to the user.

3. The method of claim 1, further comprising the steps of:
(a) compressing data for the plurality of online content sources that are stored in the data cache of the physical medium prior to the step of distributing; and
(b) decompressing the data for said at least the portion of the online content prior to the step of displaying the online content to the user.

4. The method of claim 1, further comprising the steps of:
(a) providing a software program enabling the user to access the data cache stored on the physical medium;
(b) determining a storage date of the data for said at least the portion of the online content included in the data cache, using the software program; and
(c) selectively accessing the data for said at least the portion of the online content included in the data cache prior to the step of displaying the online content to the user, only if the storage date of said data is the same as a date for the online content at the first location; and if not,
(d) transferring all of the data for the online content from the first location to the second location, to display the online content to the user.

5. The method of claim 4, further comprising the step of enabling the software program to interface with a browser in which the online content is displayed, said software program controlling whether data used for displaying the online content is received from the first location or obtained from the data cache.

6. The method of claim 4, further comprising the step of enabling the software program to collect usage information regarding online content sources selected by the user for display, for transmission over the network to a service program running at a third location, said usage information being employed by the service to determine a new plurality of specified web sites for which data will be stored in a data cache on another physical medium, for subsequent distribution to the user.

7. The method of claim 1, further comprising the step of periodically distributing to the user another physical medium on which an updated data cache is stored for a new plurality of specified online content sources.

8. The method of claim 1, further comprising the step of selecting the specified online content sources based upon a class of which the user is a member, so that the specified online content sources for which the data cache is provided on the physical medium are likely to be of interest to and selected for display by members of said class to whom the physical medium is distributed.

9. The method of claim 1, further comprising the step of updating the data cache with new data for the specific online content sources, said new data being received over the network from a third location, said step of updating occurring as a background task that is executed at a time when other data are not being transferred over the network to the second location.

10. The method of claim 1, further comprising the steps of:
(a) responding to the user requesting display of the online content by parsing the data stored in the data cache for the online content to identify uniform resource locators (URLS) referenced therein;
(b) requesting a timestamp for said URLs over the network from a service program that is executing at a third location;
(c) responding to a reply received from the service program that indicates whether the data cache for the online content is current for each URL, by obtaining data for the URL from the data cache if the data for the URL is current in the data cache; and otherwise,
(d) obtaining the data for the URL over the network.

11. The method of claim 1, further comprising the steps of:
(a) transmitting a uniform resource locator (URL), for the online content selected by a user for display, over the network to a service program being executed at a third location;
(b) creating a prefetch list of other URLs referenced on the online content;
(c) transmitting the prefetch list from the third location to the second location; and
(d) preloading data conveyed over the network into a prefetch cache at the second location, for at least one URL in the prefetch list, so that the data for said at least one URL is already available in the prefetch cache at the second location and can more rapidly be displayed to the user if said at least one URL is selected for display by the user from within the online content.

12. A method for enabling subscribers to a service to more rapidly display each of a plurality of specified online content sources, comprising the steps of:
(a) periodically collecting and storing data for each of the plurality of specified online content sources on a storage at a data center;
(b) replicating the data for the plurality of specified online content sources that are stored in the storage as a data cache stored on a plurality of distributable physical storage media;
(c) distributing a physical storage medium on which the data cache is stored, to each subscriber of the service;
(d) enabling each subscriber to install a proxy program that serves as an interface between the data cache that was received on the physical storage medium, a network over which online content sources are accessed, and a browser program with which online content sources are displayed to the subscriber; and
(e) for an online content that is being selectively accessed over the network by a subscriber, using any data for said online content that are included in the data cache received on the physical storage medium to speed the display of the online content with the browser program, by avoiding the need to transfer the data over the network from a site at which the online content is being accessed.

13. The method of claim 12, further comprising the step of collecting subscriber usage data using the proxy program, said subscriber usage data being transferred over the network to the data center to determine online content sources that should be included in the plurality of selected online content sources for which data will be collected in the future, for distribution to the subscribers, said usage data indicating online content sources that are more frequently selected by the subscribers for display with the browser program.

14. The method of claim 13, further comprising the step of employing the usage data in determining, for each of a plurality of different classes of subscribers, online content sources that are included in the plurality of specific online content sources for which data will be collected for distribution on the physical storage media to members of each class of subscribers, the specific online content sources for each class of subscribers including data for online content sources that are more frequently selected by members of that class for display with the browser program.

15. The method of claim 12, further comprising the step of publishing data cache updates to a subscriber over the network as a background task, at times when the subscriber is not currently receiving other data over the network, said data cache updates replacing expired data in the data cache stored on the physical medium that was previously distributed to the subscriber.

16. The method of claim 12, further comprising the step of using the proxy program to determine whether the data included in the data cache distributed on the physical medium for a uniform resource locator (URL) on an online content being accessed by a subscriber are current, by communicating with the data center over the network to validate said data.

17. The method of claim 12, further comprising the steps of:
(a) using the proxy program to transmit to the data center a uniform resource locator (URL) of an online content that is being accessed by a subscriber;
(b) at the data center, identifying URLs that are included in the online content being accessed and are likely to be accessed by the subscriber, to produce a prefetch list;
(c) transmitting the prefetch list from the data center to the subscriber; and
(d) in the background, using the proxy program to load data into a prefetch cache, for the URLs that are included in the prefetch list, so that a URL for which data have thus been cached, is rapidly displayed with the browser program if selected for display by the subscriber.

18. A physically distributable memory medium on which is stored a machine readable data cache, said data cache including data for a plurality of specific online content sources for use in increasing a speed with which the specific online content sources are displayed to a user by a browser program when one of the specific online content sources is selectively accessed over a network by the user, data for said specific online content from the data cache being used to display the online content in the browser program instead of data transferred from a site of the online content over the network.

19. The physically distributable memory medium of claim 18, further comprising machine readable instructions, which when executed by a computing device, cause the computing device to employ the data cache for displaying one of the specific online content sources instead of using data transferred over a network.

20. The physically distributable memory medium of claim 19, wherein the machine readable instructions, when executed by the computing device, further cause the computing device to transmit usage information to a remote site, said usage information indicating each online content accessed by a user over the network and being used in determining the specific online content sources for which data should subsequently be collected and distributed on another distributable memory medium.

21. The physically distributable memory medium of claim 19, wherein the machine readable instructions, when executed by a computing device, further cause the computing device to obtain from a remote site a prefetch list of uniform resource locators (URLs) referenced in an online content being accessed by a user, and then load data for the URLs in the prefetch list into a prefetch cache as a background task, so that the data loaded into the prefetch cache are available for immediate display if a user selects one of the URLs in the online content that is in the prefetch list for display.

22. The physically distributable memory medium of claim 18, wherein the data in the data cache stored thereon is encrypted.

23. The physically distributable memory medium of claim 18, wherein the data in the data cache stored thereon is compressed.

24. A method for enabling data referenced by a uniform reference locator (URL) included in a selected online content to be more rapidly displayed when chosen for display by a user, comprising the steps of:
(a) sending an identification of the selected online content over a network to a service operating at a remote site, said service identifying one or more URLs in the selected online content that are likely to be subsequently selected by the user for display of the data referenced thereby, and including said one or more URLs in a prefetch list;
(b) transmitting the prefetch list over the network from the service to a computing device of the user that is being employed by the user to display the selected online content; and
(c) in a background task, loading data referenced by the URLs in the prefetch list into a prefetch cache, so that the data in the prefetch cache are immediately available for use by the computing device in displaying the data, if a URL in the selected online content that is also in the prefetch list is chosen for display by the user.

25. A system for enabling an online content being accessed at a first location to be more rapidly displayed to a user disposed at a second location, comprising:
(a) a processor;
(b) a physically distributed memory medium on which is stored a data cache that includes data for a plurality of selected online content sources, said physically distributed memory medium being coupled in communication with the processor so that the data cache stored on the physically distributed memory medium is accessible by the processor;
(c) a network interface that couples the processor in communication with a network;
(d) an output device for displaying output to the user using data for an online content, said online content having been selected by a user over the network; and
(e) a memory in which are stored a plurality of machine instructions, said memory being coupled to the processor, said plurality of machine instructions, when executed by the processor, causing the processor to more rapidly display an online content selected by the user using the data in the data cache, if data for the online content selected by the user are included in the data cache stored on the physically distributed memory medium, so that the data for the online content need not be transferred over the network through the network interface.

26. The system of claim 25, wherein at least a portion of the machine instructions comprise a proxy program that is included on the physically distributed memory medium and is loaded into the memory for execution by the processor, said proxy program causing the processor to collect usage data identifying online content sources that are selected by a user for display, and then causing the processor to transmit the usage data to a data center for use in determining the selected online content sources for which data will subsequently be collected and stored on other physically distributed memory media by the data center.

27. The system of claim 26, wherein the proxy program further causes the processor to transmit an identifier for an online content that is being displayed, over the network to the data center, and to employ a prefetch list of uniform resource locators (URLs) referenced in the online content received from the data center to load data referenced by the URLs into a prefetch cache stored in the memory, so that data for a URL included in the prefetch list is immediately displayed on the output device by the processor using the data in the prefetch cache for the URL, if the URL is selected for display by a user.

28. A system for enabling data indicated by a uniform resource locator (URL) included in an online content being accessed at a first location to be more rapidly displayed to a user disposed at a second location that is coupled to the first location over a network, comprising:
(a) a processor;
(b) a network interface that couples the processor in communication with a network;
(c) an output device for displaying an online content selected by a user over the network; and
(d) a memory in which are stored a plurality of machine instructions, said memory being coupled to the processor, said plurality of machine instructions, when executed by the processor, causing the processor to transmit an identifier for an online content that is being displayed over the network to a data center, and to employ a prefetch list of uniform resource locators (URLs) referenced in the online content received from the data center to load data referenced by the URLs into a prefetch cache stored in the memory, so that data for any URL included in the prefetch list is immediately displayed on the output device by the processor using the data in the prefetch cache for the URL, if the URL is selected for display by a user.
